(19) United States
(12) Patent Application Publication
(10) Pub. No.: US 2010/0243974 A1
(43) Pub. Date: Sep. 30, 2010

(54) Apparatus and method for entering information on small keyboards

(76) Inventor: William Jaeger, Orland Park, IL (US)

Correspondence Address: William Jaegar, 14701 Golf Road, Orland Park, IL, 60462, US

(21) Appl. No.: 12/660,734

(22) Filed: Mar. 4, 2010

Related U.S. Application Data
(60) Provisional application No. 61/211,195, filed on Mar. 27, 2009.

(51) Int. Cl. B66F 19/00

(52) U.S. Cl. 254/133 R

(57) ABSTRACT

There is disclosed an apparatus and method for entering information on small keyboards where the apparatus is worn on the thumb or finger like a ring and has a protrusion that is securely attached to said apparatus and acts as an extension of the thumb or finger when striking keys on a small keyboard. The apparatus can be made of, or in combination of, elastic, plastic, rubber, velcro, or other suitable material that fits snugly over the thumbs or fingers.

### CROSS-REFERENCE TO RELATED APPLICATIONS

This patent application claims the benefit of U.S. Provisional Application No. 61/211/195 filed on 27 March, 2009, (Mar. 27, 2009) and entitled “System for Entering Information on Small Keyboards”, the disclosure of which is incorporated herein by reference in its entirety.

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISC APPENDIX

Non Applicable

### BACKGROUND OF THE INVENTION

1. Field of the Invention

This invention relates generally to the texting of messages and more particularly to the use of very small keyboards to enter information. The popularity of small telephones, GPS units, Blackberry computers, and other electronics creates a competitive market for such electronics. The smaller the gadgets become, the more desirable and popular they become. The older versions of electronic equipment that displayed large keyboards were much larger than the newly manufactured products, and did not present a problem of “keying” incorrect keys or “keying” two keys at the same time. Currently, by “keying” the incorrect key, an individual could alter the intended message or task, and present many problems.

2. Description of the Related Art

Some of the newer electronics that have a small keyboard rely upon a small pencil like striker to key the miniature keys. The use of this single striker is fairly slow and relates to typing on a keyboard with one finger. The small pencil like striker is easy to misplace, is not efficient, and adds frustration to the user.

### BRIEF SUMMARY OF THE INVENTION

It is an object of the invention to provide an apparatus and method for entering information on small keyboards with accuracy.

It is a further object of the instant invention to provide an apparatus and method for entering information on small keyboards without strain on hands and fingers as one attempts to “key in” information.

It is another object of the invention to permit the user to enter information on small keyboards with speed.

The present invention overcomes the deficiencies of hand entering information on small keyboards by providing a system for entering information on small keyboards comprising of a set of thumb or finger attachments. These thumb or finger attachments have an extension that acts as a striker for each key chosen for activation. The thumb or finger attachments have a striker or protrusion that is approximately ½ inch long, and 3/16 inch in diameter made of non-slip hard rubber, or other appropriate material so as to not create a bothersome sound as keys are stricken. The thumb or finger attachment can be made of, or in combination of, Plastic, Elastic, Cloth, Velcro, Rubber or other suitable material. The material and construction of the thumb or finger attachments will provide a one size fits all application or offer a various size selection. The thumb or finger attachments shall be comfortable for long usage, and be easily removed or worn loosely when not in use. The design of the thumb or finger attachments would not interfere with long fingernails. The thumb or finger attachments would be lightweight, durable, and pleasing to the eye.

When in use, the invention would enable the user to easily and accurately strike the keys on small keyboards. When in use, the invention would be worn on the end of the user's thumbs or fingers like a ring, located approximately where the thumb or finger nail base meets the skin of the thumbs or fingers, with the striker being located on the “fingerprint” side of the thumb or finger, and would act as an extension of the thumb or finger when striking different keys on small keyboards. The common method of using these electronic devices with small keyboards, is to hold the device with two hands, with the keyboard facing the user, and steadying the device with the fingers under the device, leaving the thumbs somewhat free to alternately strike the keys. An alternate method of use would enable the user to hold the electronic device in one hand, wearing the invention on the fingers of the opposite hand and striking the keys as one would type with one or two fingers.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form. These and other objects and advantages of the instant invention will be apparent from the following description and drawings.

### BRIEF DESCRIPTION OF THE SEVERAL VIEWS OF THE DRAWINGS

Other aspects, features, and advantages of the present invention will become more fully apparent from the following detailed description, the appended claim, and the accompanying drawings.

FIG. 1 is a perspective view of the instant invention in use;

FIG. 2 is a preferred embodiment of the instant invention;

FIG. 3 is a preferred embodiment of the striker of the instant invention;

FIG. 4 is a perspective view an alternate preferred embodiment of the instant invention in use;

FIG. 5 is a view of an alternate preferred embodiment of the instant invention;

FIG. 6 is a perspective view of an alternate preferred embodiment of the instant invention in use; and

FIG. 7 is a view of an alternate preferred embodiment of the instant invention.

### DETAILED DESCRIPTION OF THE INVENTION

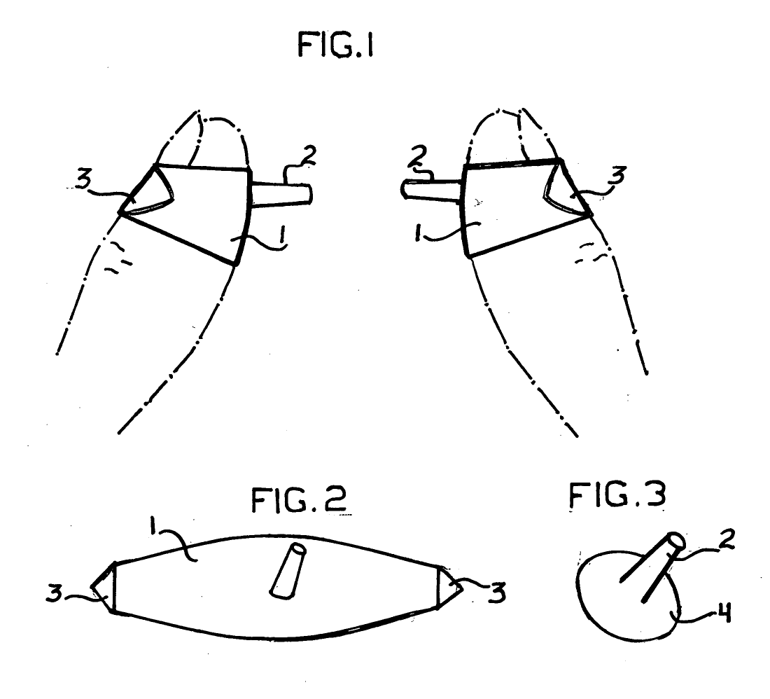

To provide an apparatus and method for entering information on small keyboards, there is provided a set of thumb or finger attachments as shown in FIG. 1, comprised of a length of elastic material 1 with a striking protrusion 2 approximately ½ inch long and 3/16 inches in diameter. The length of elastic material 1 can be wrapped around the end of the thumb or finger with the striking protrusion 2 facing outward and fastened with velcro tabs 3 enabling the wearer to size the thumb or finger attachment to their needs. When in position the apparatus is situated near the outward end of the thumb or finger as shown in FIG. 1. The invention acts as an extension of the thumbs or fingers. FIG. 2 shows the outward side of the apparatus before placement around the thumb or finger for use. FIG. 3 shows the striker 2 with its flat base 4 that when in place in the invention provides a finger pad for striking the keys of an electronic device.

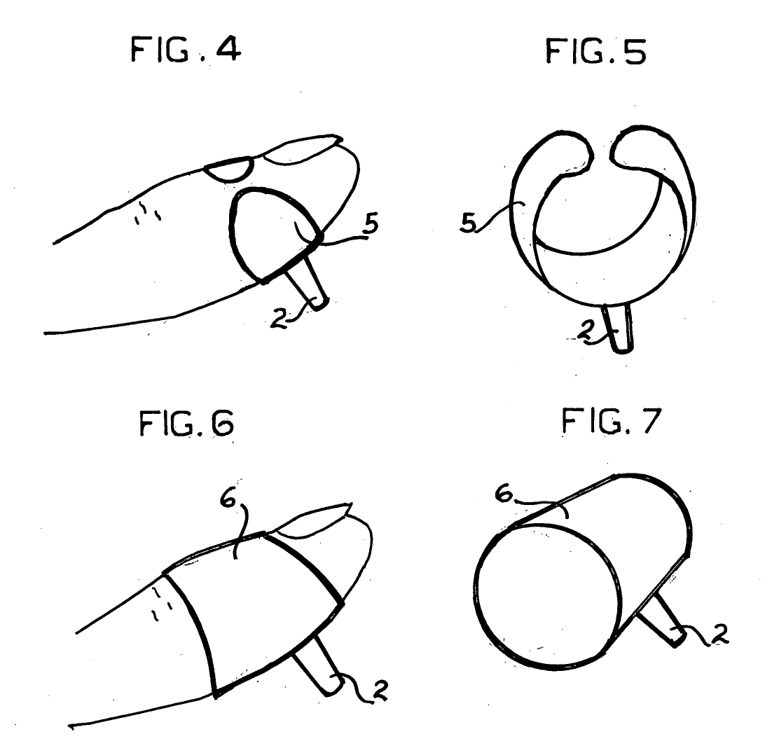

An alternate preferred embodiment of the invention consists of a set of split ring thumb or finger attachments. FIG. 4 shows the apparatus in place for use. FIG. 5 shows the apparatus not in place. Each attachment consists of plastic split ring 5 fitted with a striking protrusion 2 as shown in FIG. 4 and FIG. 5. The plastic ring 5 is split and is soft enough so as to permit it to spread to ensure a snug fit to the wearer.

Another alternate preferred embodiment of the invention consists of a set of thumb or finger attachments, each consisting of an elastic or rubber thumb or finger sleeve 6 fitted with a striking protrusion 2 that when in place is situated near the outer end of the thumb or finger acting as an extension of the thumb or finger, as shown in FIG. 6. FIG. 7 shows the attachment not in use consisting of an elastic sleeve 6 containing a striking protrusion 2. The elastic sleeve thumb or finger attachment enables the wearer to slip the attachment onto the thumb or finger for a comfortable snug fit before use.

It should be understood that various changes and modifications to the preferred embodiments described herein will be apparent to those skilled in the art. Such changes and modifications can be made without departing from the spirit and scope of the instant invention and without diminishing its attendant advantages. It is therefore intended that such changes and modifications be covered by the forthcoming claims.

What is claimed is:

1. Apparatus for entering information on small keyboards, said apparatus comprising:
a set of thumb or finger attachments;
said thumb or finger attachments having a protrusion extending outward from the exterior of the attachments to serve as strikers for activating keys on a tiny keyboard;
wherein said thumb or finger attachments are adapted to be worn by all.

2. The apparatus for entering information on tiny keyboards of claim 1, wherein the apparatus is worn on the thumbs or fingers with the protrusion extending outward from the fingerprint side of the thumbs or fingers.

3. The apparatus for entering information on tiny keyboards of claim 2, wherein the protrusions are made of a non-slip rubber like material.

4. The apparatus for entering information on tiny keyboards of claim 2, wherein the protrusions are made of plastic.

5. The apparatus for entering information on tiny keyboards of claim 2, wherein the thumb or finger attachments are made of a plastic and or rubber.

6. The apparatus for entering information on small keyboards of claim 2, wherein the thumb or finger attachments are made of elastic material and or rubber.

7. The apparatus for entering information on small keyboards of claim 2, wherein the thumb or finger attachments made of velcro and or rubber.

8. A method for entering information on small keyboards, said method comprises:
providing a set of thumb or finger attachments;
providing said thumb or finger attachments having a protrusion extending outward from the exterior of the attachments to serve as strikers for activating keys on a small keyboard;
wherein said thumb or finger attachments are adapted to be worn by all.

9. The method for entering information on small keyboards of claim 8, wherein the apparatus is worn on the thumbs or fingers with the protrusion extending outward from the fingerprint side of the thumbs or fingers.

10. The method for entering information on small keyboards of claim 9, wherein the protrusions are made of a non-slip rubber like material.

11. The method for entering information on small keyboards of claim 9, wherein the protrusions are made of plastic.

12. The method for entering information on small keyboards of claim 9, wherein the thumb or finger attachments are made of a plastic and or rubber.

13. The method for entering information on small keyboards of claim 9, wherein the thumb or finger attachments are made of elastic material and or rubber.

14. The method for entering information on small keyboards of claim 9, wherein the thumb or finger attachments are made of velcro and or rubber.
